(19) United States
(12) Patent Application Publication
(10) Pub. No.: US 2024/0051179 A1
(43) Pub. Date: Feb. 15, 2024

(54) Method for producing wood fiber insulating material products, and wood fiber insulating material product

(71) Applicant: Fraunhofer-Gesellschaft zur Förderung der angewandten Forschung e.V., München (DE)

(72) Inventors: Nina RITTER, BRAUNSCHWEIG (DE); Christian RECK, Neustadt am Rübenberge (DE); Peter MEINLSCHMIDT, BRAUNSCHWEIG (DE)

(21) Appl. No.: 18/256,002

(22) PCT Filed: Dec. 7, 2021
(86) PCT No.: PCT/EP2021/084540

§ 371 Date: Jun. 5, 2023

(30) Foreign Application Priority Data
Dec. 8, 2020 (DE) 10 2020 132 552.5

(51) Int. Cl. B27N 3/00; B27N 3/04; B27N 3/24; B27N 1/02

(52) U.S. Cl. CPC B27N 3/002; B27N 3/04; B27N 3/24; B27N 1/02

(57) ABSTRACT

The invention relates to a method for producing flexible or elastic wood fiber insulating material products, having the following steps: -providing wood fibers which have been produced in a refiner. -providing multicomponent fibers with an inner and an outer component, said outer component melting or fusing at a melting temperature at which the inner component does not melt or fuse or has not yet melted or fused. -providing a mixture of wood fibers and multicomponent fibers. -heating the mixture to a temperature at which the outer component melts or fuses, and—connecting the multicomponent fibers together and to the wood fibers while cooling the mixture, wherein hardwood fiber bundles, in particular beechwood fiber bundles, are used as the wood fibers, and biodegradable multicomponent fibers are used as the multicomponent fibers.

The invention relates to a method for producing flexible or elastic wood fiber insulant products, by providing wood fibers which have been produced in a refiner and also multicomponent fibers having an inner and an outer component, where the outer component melts or starts to melt at a melting temperature at which the inner component does not, or not yet, melt or start to melt and by heating a mixture of wood fibers and multicomponent fibers to a temperature at which the outer component melts or starts to melt, and joining the multicomponent fibers to one another and/or to the wood fibers on cooling of the mixture. The invention likewise relates to a wood fiber insulant product with wood fibers which have been produced in a refiner and with multicomponent fibers having an inner and an outer component, where the outer component melts or starts to melt at a melting temperature at which the inner component does not, or not yet, melt or start to melt and the wood fibers and multicomponent fibers are joined to one another by heating and melting or incipient melting of the outer component and concluding cooling.

Wood-based boards are, for example, particle boards, oriented strand boards (OSB), and medium-density and high-density fiber boards, referred to as MDF and HDF boards. These boards are produced using wood chips or wood fibers which are mixed with thermoset binders and pressed to a dimensionally stable board material in general in a continuous press at high pressure and high temperatures. Wood-based boards of these kinds are used generally as structural components, formwork elements, floor coverings, wall paneling or the like, and combine a comparatively high strength with easy workability and high resistance to pest infestation. Furthermore, wood-based boards can be provided with suitable additives in order to meet the fire safety requirements. Wood-based boards are produced in a wet process or in a dry process.

While solid wood already possesses good heat insulation properties, an improved insulating effect may be obtained by increasing the porosity in materials by defibrating the wood. The defibration, for example, of wood chips takes place in a refiner, for example. The wood fibers, which are subsequently dried for the dry process, are separated in a cyclone and conveyed via a belt weigher to a fiber mixer, in which the wood fibers, generally softwood fibers, are mixed with binding fibers composed of plastic. A scattering machine transports the fiber mixture onto a circulating conveyor belt. Here, the density can be determined using an X-ray scanner and the fiber web can be homogenized with a facility for standardizing the distribution of material. The height of the web is adjusted via two belts which circulate in parallel with the spacing between them being adjustable. Under the gentle pressure of the belts, the web, through which a flow of hot air is passed in order to achieve thermal activation of binding fibers, is. Wood fiber insulants of these kinds are produced as boards or mats or in loose form, where comparatively high thicknesses of 20 mm to 300 mm are produced in conjunction with apparent densities of between 40 kg/m3 to 230 kg/m3.

DE 10 2004 062 649 B4 discloses methods for producing wood fiber insulant boards/wood fiber insulant mats by introducing wood fibers and binding fibers from bale openers uniformly into a blowline and supplying them pneumatically through a blowline to a reservoir container. From the reservoir container, the fiber mixture is blown onto a first transport belt, the fibers being spatially oriented in the process. At the end of the first transport belt, the resulting web is defibrated and, after having been mixed again, is blown onto a second transport belt with spatial orientation of the fibers. The thickness of the resulting mat is adjusted by the circulating speed of the second transport belt. The product thus obtained is guided onto an oven belt, on which it is passed through a heating oven and a cooling oven. In these ovens, the binding fibers are softened, and hence the wood fibers are intimately bonded and the ultimate thickness of the wood fiber insulant board/wood fiber insulant mat is adjusted, and cooling takes place. It is also possible to add plastic pellets which consist of a thermally stable core and a covering of synthetic resins which soften at the temperatures prevailing in the heating zone.

DE 10 2008 039 720 A1 discloses a method for producing wood fiber insulating boards where wood fibers are mixed with thermoplastic fibers as binders. A fiber mat is produced from this mixture, with synthetic fibers used comprising multicomponent fibers which consist of at least one first and one second plastics component having different melting temperatures. The fiber mat is heated, and so the second component of the plastics fibers is softened. For the heating, steam or a steam/air mixture is passed through the fiber mat, with the steam/air mixture having a specified dew point, the first component having a melting point above the dew point and the second component having a melting point below the dew point.

WO 2002/22331 A1 discloses a method for producing shaped elements in board form based on natural fibers, by mixing natural fibers with binders, delivering the mixture at a shaping station, optionally shaping and lastly binding the mixture. The binder is admixed in the form of elemental bodies that form binder at least partially after activation. The elemental bodies may be fibers formed of hotmelt adhesive.

Common to the methods is that fresh softwoods are comminuted into chips and in a thermomechanical process are defibrated in a refiner and dried. Even now, such wood fibers are not available in any desired amount, and because of the climate change they will be available only in markedly lower amounts for comminution. Furthermore, the multicomponent fibers have been provided with a plastics fraction, presenting an environmental problem. The plastics fraction has virtually no biodegradability, or none, so increasing the problem of microplastics in the environment.

It is an object of the present invention to specify a wood fiber insulant product and also a method for producing it that is environmentally advantageous.

This object is achieved in accordance with the invention by a method having the features of the main claim and a wood fiber insulant product having the features of the alternative independent claim. Advantageous refinements and developments of the invention are disclosed in the dependent claims and the description.

The method for producing flexible or elastic wood fiber insulant products, more particularly wood fiber insulant mats, wood fiber insulant boards or else fillings of building materials such as hollow bricks, allows first for the provision of wood fibers which have been produced in refiner, and additionally the provision of multicomponent fibers having an inner and an outer component, the outer component melting or starting to melt at a melting temperature at which the inner component does not, or not yet, melt or start to melt, and, moreover, the provision of a mixture of wood fibers and multicomponent fibers, and the heating of the mixture to a temperature at which the outer component melts or starts to melt, and also the joining of the multicomponent fibers to one another and/or to the wood fibers on cooling of the mixture, where wood fibers used comprise hardwood fiber bundles, more particularly beechwood fiber bundles, and multicomponent fibers used comprise biodegradable multicomponent fibers. The use both of wood fiber bundles and of biodegradable multicomponent fibers has the advantage that the wood fiber insulant product is fully biodegradable and, furthermore, makes do with raw materials which are present in sufficient availability. Coniferous trees (softwood) in particular are at risk in the stand, owing to the climatic changes, whereas s deciduous trees (hardwood) are sufficiently available and less heavily subject to the climate change. The economic exploitation of commercial forests has already changed, with a preference for mixed forests; however, owing to the long renewal cycles, this will have noticeable effects only in several decades. The multicomponent fibers can be broken down both thermally and microbially or by fungi and in particular are compostable, so enabling easy disposal of wood fiber insulant products that are no longer required. The wood fibers in this case are not comminuted into individual wood fibers as in conventional processes, but are instead left as hardwood fiber bundles, so preventing the production of fine material during the production of the required starting materials. In this way, wood fiber insulant products can be produced, especially mats or boards, which have sufficient dimensional stability and are flexible and in particular elastic. After the melting, the multicomponent fibers join in particular both with one another and with the wood fibers and form a structure and joining points at which the wood fibers and other multicomponent fibers are held adhesively in the course of the cooling.

In one development, the hardwood fiber bundles are produced in the refiner in a length of between 0.5 mm and 10 mm and a width of 0.1 mm and 2 mm and are subsequently mixed with the multicomponent fibers as binding fibers. The major part of the wood fibers used are within this size range, i.e., more than 50%, more particularly more than 75%, of the wood fibers used, and so a homogeneous wood fiber insulant board or a homogeneous wood fiber insulant product is produced. This means that the fine fiber fraction of the wood fibers is minimized by a larger distance between the refiner grinding plates.

The outer component advantageously has a melting temperature of below 100° ° C., more particularly of below 70° C., since a melting temperature of below 100° C. is considered in the context of industrial composting plants to be an upper limit below which any ignition risk is classed as being manageable or negligible.

In one variant, the inner component may take the form of a nonmelting material, more particularly of a biofiber, composed for example of flax, hemp, sisal, jute or the like, which is clad wholly or partly with the outer component. The inner component used may alternatively be a biodegradable polyamide, which can provide sufficient flexibility and elasticity to the product produced.

In one development, the use of polylactides is contemplated as outer component in the multicomponent fiber, these polylactides being based on lactic acid and enabling easy processability in conjunction with biodegradability.

In one variant, not more than 7.5% of multicomponent fibers are used, based on the mass of the wood fibers, in order first to reduce the consumption of adhesives and secondly to minimize the energy needed for activating the outer component. With the low fraction of multicomponent fibers, furthermore, there is a cost reduction and the biodegradability is improved.

The multicomponent fibers can be mixed with the wood fibers in a blowline. In one variant, the mixing of multicomponent fibers with wood fibers takes place with a pin roll. The mixing may alternatively take place in a cyclone and/or in a hammer mill without sieve. After the mixing of the multicomponent fibers with the wood fibers, this mixture is introduced into a mold, where it is heated. Alternatively, and especially when producing boards or mats, the mixture may be scattered onto a sieve belt or conveyor belt and brought to the desired height with application of little pressure, and at the same time heated, and subsequently cooled, to provide a product having the desired end properties and end dimensions after cooling. The mixture, for example, may also be introduced into an element for insulation, a hollow brick, for example, which is subsequently heated and cooled and then has an inner filling of the wood fiber insulant.

Before the heating, in particular also before the mixing with the multicomponent fibers, the wood fibers may be provided with a flame retardant and/or with water impregnation in order to modify and establish the properties of the end product. Such additives are added in particular in a blowline, this being a pneumatic conveying facility, in order to achieve uniform mixing and wetting/impregnation of the wood fibers/hardwood fiber bundles.

In one development, the fiber mixture is oriented along a principal plane, such as principal board plane, principal product plane or principal mat plane, for example, by means of a stream of air or by electrostatic charging, for example, so that a predominant fraction of fibers are aligned parallel to a board plane. In this case there are of course fibers aligned perpendicular to the principal plane or board plane, in order to achieve a porous structure in the end product and to provide for mutual spacing between the fiber planes aligned substantially parallel to one another. Through such orientation of the fiber mixture in the board plane, an improved insulating effect is achieved, since the thermal conduction longitudinally and transversely to the fiber alignment differs by a factor of 2. The fibers may be oriented, for example, by being drawn under suction onto a sieve and by corresponding routing of air.

In one development, the insulant product is produced with a density in a range between 35 kg/m3 and 75 kg/m³, and a gentle pressure is or may be applied to the mixture before the heating in order to ensure sufficient contact of the fibers with one another during the heating.

The outer component may be heated via hot air, hot steam, microwaves and/or high-frequency radiation, with the temperature established being just sufficient to melt or start to melt the outer component and enabling sufficient bonding to the other multicomponent fibers and to the hardwood fiber bundles.

In order to produce an insulant board or an insulant mat, a fiber web composed of the wood fibers and the multicomponent fibers is scattered onto a circulated conveyor belt and compressed and heated in a continuous production process, using in particular a continuous sieve belt oven having an installed press function, without exerting a high pressure or high compression on the fiber web.

The wood fiber insulant product with wood fibers, which have been produced in a refiner, and with multicomponent fibers having an inner and an outer component, the outer component melting or starting to melt at a melting temperature at which the inner component does not, or not yet, melt or start to melt, and wood fibers and multicomponent fibers are joined to one another by heating and melting or incipient melting of the outer component and subsequent cooling, allows for the use as wood fibers of hardwood fiber bundles, more particularly beechwood fiber bundles, and for the use as multicomponent fibers of biodegradable multicomponent fibers. The wood fiber insulant product may be configured as a board or a mat, and the fibers, not only the multicomponent fibers but also the hardwood fiber bundles, are oriented at least regionally predominantly along a principal plane of a board or mat. The insulating effect is improved as a result.

In one refinement, the wood fiber insulant product has a density in a range between 35 kg/m3 and 75 kg/m³, with the outer component having a melting point of less than 100° C., preferably less than 70° C. With such a low melting point it is possible for the biodegradable outer component, a polylactide for example, to be biodegraded as part of a composting process.

In one refinement, the multicomponent fibers have a weight fraction of less than 7.5%, more particularly a mass fraction of 2.5% or 5% of the mass of the wood fibers, thereby reducing the overall product, since the comparatively expensive multicomponent fibers are used only to a small extent.

In one development, the wood fiber insulant product is of flexible, more particularly elastic, configuration and may be used in particular as insulation between rafters for the thermal insulation of roofs. Furthermore, the insulant product may be used as packaging material by virtue of the elastic properties, so as to replace or reduce plastic packaging material.

1. A method for producing flexible or elastic wood fiber insulant products, comprising:
providing wood fibers which have been produced in a refiner,
providing multicomponent fibers wherein each of the multicomponent fibers comprises an inner component and an outer component, wherein the outer component melts or starts to melt at a first melting temperature, wherein the inner component melts or starts to melt at a second melting temperature, wherein the second melting temperature is higher than the first melting temperature,
preparing a mixture of the wood fibers and the multicomponent fibers,
heating the mixture to the first melting a temperature, and
joining a plurality of the multicomponent fibers together and to a plurality of the wood fibers by cooling the mixture, wherein the wood fibers comprise hardwood fiber bundles, and wherein the multicomponent fibers comprise biodegradable multicomponent fibers.

2. The method as claimed in claim 2, wherein the hardwood fiber bundles are produced in the refiner in a length of 0.5 mm to 10 mm and a width of 0.1 mm to 2 mm.

3. The method as claimed in claim 1 wherein the first melting temperature is below 100° C.

4. The method as claimed in claim 1 wherein the inner component is a nonmelting material, fibers of a renewable material, or a polyamide.

5. The method as claimed in claim 1 wherein the outer component of the multicomponent fibers comprises one or more polylactides.

6. The method as claimed in claim 1 wherein not more than 7.5% of multicomponent fibers are used in the mixture, based on the mass of the wood fibers.

7. The method as claimed in claim 1 wherein the multicomponent fibers are mixed when preparing the mixture with the wood fibers
in a blowline,
with a pin roll, and/or
in a cyclone and/or in a hammer mill without sieve, and
wherein the multicomponent fibers and the wood fibers are mixed before introduction into a mold or scattering onto a press belt.

8. The method as claimed in claim 1 wherein the wood fibers are provided with a flame retardant and/or with water impregnation.

9. The method as claimed in claim 1 wherein the mixture, before the heating step, is oriented along a principal board plane.

10. A The method of claim 1 wherein the flexible or elastic wood fiber insulant products have a density in a range between 35 kg/m³ and 75 kg/m³.

11. The method as claimed in claim 1 wherein the outer component is heated in the heating step via hot air, hot steam, microwaves and/or high-frequency radiation.

12. The method as claimed in claim 1 further comprising scattering a fiber web formed in the joining step onto a circulated conveyor belt and compressing and heating the fiber web in a continuous production process.

13. A wood fiber insulant product, comprising: with
wood fibers which have been produced in a refiner, and
multicomponent fibers each of which comprise an inner component and an outer component,
wherein the outer component melts or starts to melt at a first melting temperature,
wherein the inner component melts or starts to melt at a second melting temperature,
wherein the second melting temperature is higher than the first melting temperature,
wherein a plurality of the wood fibers and a plurality of the multicomponent fibers are joined together by mixing together the wood fibers and the multicomponent fibers to form a mixture, heating and melting or incipient melting of the outer component of the multicomponent fibers in the mixture, and then cooling the mixture,
wherein the wood fibers used comprise hardwood fiber bundles, and
wherein the multicomponent fibers comprise biodegradable multicomponent fibers.

14. The wood fiber insulant product as claimed in claim 13, wherein the wood fiber insulant product is configured as a board or mat, and wherein one or more of the wood fibers and the multicomponent fibers at least regionally are oriented predominantly along a principal plane of the board or mat.

15. The wood fiber insulant product as claimed in claim 13 wherein the wood fiber insulant product has a density in a range between 35 kg/m³ and 75 kg/m³.

16. The wood fiber insulant product as claimed in claim 13 wherein the outer component has a melting temperature of less than 100° C.

17. The wood fiber insulant product as claimed in claim 13 wherein the multicomponent fibers account for a mass fraction of less than 7.5% of the wood fiber insulant product.

18. The wood fiber insulant product as claimed in claim 13 wherein the wood fiber insulant product is of a flexible or elastic configuration.

19. The method of claim 1 wherein the hardwood fiber bundles comprise beechwood fiber bundles.

20. The wood fiber insulant product of claim 13 wherein the hardwood fiber bundles comprise beechwood fiber bundles.
